(19) United States
(12) Patent Application Publication
(10) Pub. No.: US 2017/0177004 A1
(43) Pub. Date: Jun. 22, 2017

(54) METHOD AND DEVICE FOR RETRIEVING UNMANNED AERIAL VEHICLE BY HAND AND UNMANNED AERIAL VEHICLE

(71) Applicant: BEIJING ZERO ZERO INFINITY TECHNOLOGY CO., LTD, Beijing (CN)

(72) Inventors: Mengqiu WANG, Beijing (CN); Tong ZHANG, Beijing (CN); Qicheng LI, Beijing (CN); Jia LU, Beijing (CN); Lixin LIU, Beijing (CN)

(73) Assignee: BEIJING ZERO ZERO INFINITY TECHNOLOGY CO., LTD, Beijing (CN)

(21) Appl. No.: 15/115,789

(22) PCT Filed: Jan. 11, 2016
(86) PCT No.: PCT/CN2016/070581

§ 371 Date: Aug. 1, 2016

(30) Foreign Application Priority Data
Aug. 10, 2015 (CN) 201510487412.7

(51) Int. Cl. G05D 1/08; B64C 39/02

(52) U.S. Cl. CPC G05D 1/0808; B64C 39/024; B64C 2201/108; B64C 2201/182

(57) ABSTRACT

A method and a device for retrieving an unmanned aerial vehicle by a hand and an unmanned aerial vehicle are provided. The method includes: detecting a state parameter of the unmanned aerial vehicle in real time; determining whether the unmanned aerial vehicle is disturbed by a hand according to the state parameter of the unmanned aerial vehicle; and controlling a rotor wing of the unmanned aerial vehicle to stop rotation if it is determined that the unmanned aerial vehicle is disturbed by the hand. The unmanned aerial vehicle is retrieved directly by the hand without using a remote control device.

### CROSS REFERENCE OF RELATED APPLICATION

This application claims the priority to Chinese Patent Application No. 201510487412.7, titled “METHOD AND DEVICE FOR RETRIEVING UNMANNED AERIAL VEHICLE BY HAND AND UNMANNED AERIAL VEHICLE”, filed on Aug. 10, 2015 with State Intellectual Property Office of PRC, which is hereby incorporated by reference in its entirety.

### FIELD

The disclosure relates to the technical field of unmanned aerial vehicle control, and in particular to a method and a device for retrieving an unmanned aerial vehicle by a hand and an unmanned aerial vehicle.

### BACKGROUND

Presently, an unmanned aerial vehicle is more widely used, for example, in shooting at a high altitude, and in shooting in a sport event and an important conference.

In the conventional technology, the unmanned aerial vehicle is retrieved in such a way that the unmanned aerial vehicle is controlled to land on a plane by a remote controller or a device (e.g., cellphone) similar to the remote controller, and then the unmanned aerial vehicle is retrieved manually.

However, in order to retrieve the unmanned aerial vehicle in such a way, a user is required to control the unmanned aerial vehicle to fly to a position over a landing point by operating the remote controller, which requires the user to be skillful in operating the remote controller. If the user is not familiar with the remote control operation of the unmanned aerial vehicle, the unmanned aerial vehicle can not be retrieved quickly. In addition, when the unmanned aerial vehicle is retrieved in such a way, the unmanned aerial vehicle may fall freely for a distance before being landed on the landing plane, and the unmanned aerial vehicle is likely to be damaged during the free fall. Finally, by retrieving the unmanned aerial vehicle in such a way, the user has a strong steering feeling, and has an unnatural interaction with a machine.

Therefore, there is a need for a person of skill in the art to provide a method and a device for retrieving a unmanned aerial vehicle by a hand, with which the unmanned aerial vehicle can be retrieved without using the remote controller and the interaction between human and machine is better achieved.

### SUMMARY

To solve the technical problem, a method and a device for retrieving an unmanned aerial vehicle by a hand and an unmanned aerial vehicle are provided to retrieve the unmanned aerial vehicle by a hand without using a remote controller, thus an interaction between human and machine is achieved.

It is provided a method for retrieving an unmanned aerial vehicle by a hand according to the embodiments of the disclosure. The method is applicable to the unmanned aerial vehicle and includes:

detecting a state parameter of the unmanned aerial vehicle in real time;

determining whether the unmanned aerial vehicle is disturbed by a hand according to the state parameter of the unmanned aerial vehicle; and

controlling a rotor wing of the unmanned aerial vehicle to stop rotation if it is determined that the unmanned aerial vehicle is disturbed by the hand.

Preferably, the state parameter of the unmanned aerial vehicle includes a position parameter of the unmanned aerial vehicle and an attitude parameter of the unmanned aerial vehicle; and

the determining whether the unmanned aerial vehicle is disturbed by a hand according to the state parameter of the unmanned aerial vehicle comprises:

acquiring a total position variation of the unmanned aerial vehicle based on the position parameter of the unmanned aerial vehicle;

acquiring a total attitude variation of the unmanned aerial vehicle based on the attitude parameter of the unmanned aerial vehicle; and

determining that the unmanned aerial vehicle is disturbed by the hand in a case that the total position variation of the unmanned aerial vehicle is greater than or equal to a preset threshold of the position variation and the total attitude variation of the unmanned aerial vehicle is greater than or equal to a preset a threshold of the attitude variation.

Preferably, the position parameter of the unmanned aerial vehicle is acquired by fusing data detected by an accelerometer, data of the unmanned aerial vehicle relative to a feature point on the ground detected by a camera arranged on a side of the unmanned aerial vehicle facing the ground and distance data between the unmanned aerial vehicle and the ground detected by a sonar; and

the attitude parameter of the unmanned aerial vehicle may be acquired by fusing the data detected by the accelerometer and data detected by a gyroscope.

Preferably, the total position variation of the unmanned aerial vehicle Vₜ_{ᵢ}^{P} is acquired based on the position parameter of the unmanned aerial vehicle with the following equation:

Vₜ_{ᵢ}^{P}=|dxᵢ|+|dyᵢ|+|dzᵢ|,

where (xᵢ, yᵢ, zᵢ) is the position parameter of the unmanned aerial vehicle at an instant tᵢ, xᵢ and yᵢ are two-dimensional coordinates in a plane parallel to the ground respectively, zᵢ is a coordinate on an axis perpendicular to the ground, and tᵢ is a timestamp; and

the total attitude variation of the unmanned aerial vehicle Vₜ_{ᵢ}^{O} is acquired based on the attitude parameter of the unmanned aerial vehicle Vₜ_{ᵢ}^{O} with the following equation:

Vₜ_{ᵢ}^{O}=|dφᵢ|+|dθᵢ|+|dψᵢ|,

where (φᵢ, θᵢ, ψᵢ) is the attitude parameter of the unmanned aerial vehicle at instant tᵢ, and

the determining that the unmanned aerial vehicle is disturbed by the hand in a case that the total position variation of the unmanned aerial vehicle is greater than or equal to a preset threshold of the position variation and the total attitude variation of the unmanned aerial vehicle is greater than or equal to a preset a threshold of the attitude variation includes:

determining that the unmanned aerial vehicle is disturbed by the hand in a case that a maximum of the total position variation of the unmanned aerial vehicle is greater than or equal to a preset threshold of the position variation and a maximum of the total attitude variation of the unmanned aerial vehicle is greater than or equal to a preset threshold of the attitude variation during a predetermined time window (tₐ, t_{b}).

It is further provided a control device for retrieving an unmanned aerial vehicle by a hand. The control device is applicable to the unmanned aerial vehicle and includes:

a detection unit configured to detect a state parameter of the unmanned aerial vehicle in real time;

a determining unit configured to determine whether the unmanned aerial vehicle is disturbed by a hand according to the state parameter of the unmanned aerial vehicle; and

a control unit configured to control a rotor wing of the unmanned aerial vehicle to stop rotation if it is determined that the unmanned aerial vehicle is disturbed by the hand.

Preferably, the state parameter of the unmanned aerial vehicle may include a position parameter of the unmanned aerial vehicle and an attitude parameter of the unmanned aerial vehicle; and

the determining unit includes:

a total position variation acquisition sub-unit configured to acquire a total position variation of the unmanned aerial vehicle based on the position parameter of the unmanned aerial vehicle;

a total attitude variation acquisition sub-unit configured to acquire a total attitude variation of the unmanned aerial vehicle based on the attitude parameter of the unmanned aerial vehicle; and

a determining sub-unit configured to determine that the unmanned aerial vehicle is disturbed by the hand in a case that the total position variation of the unmanned aerial vehicle is greater than or equal to a preset threshold of the position variation and the total attitude variation of the unmanned aerial vehicle is greater than or equal to a preset threshold of the attitude variation.

Preferably, the position variation acquisition sub-unit is configured to acquire the total position variation of the unmanned aerial vehicle Vₜ_{ᵢ}^{P} with the following equation:

Vₜ_{ᵢ}^{P}=|dxᵢ|+|dyᵢ|+|dzᵢ|,

where (xᵢ, yᵢ, zᵢ) is the position parameter of the unmanned aerial vehicle at instant tᵢ, xᵢ and yᵢ are two-dimensional coordinates in a plane parallel to the ground respectively, and zᵢ is a coordinate on an axis perpendicular to the ground; and

the attitude variation acquisition sub-unit is configured to acquire the total attitude variation of the unmanned aerial vehicle Vₜ_{ᵢ}^{O} with the following equation:

Vₜ_{ᵢ}^{O}=|dφᵢ|+|dθᵢ|+|dψᵢ|,

where (φᵢ, θᵢ, ψᵢ) is the attitude parameter of the unmanned aerial vehicle at instant tᵢ, and

the determining sub-unit is configured to determine that the unmanned aerial vehicle is disturbed by the hand in a case that a maximum of the total position variation of the unmanned aerial vehicle is greater than or equal to a preset threshold of the position variation and a maximum of the total attitude variation of the unmanned aerial vehicle is greater than or equal to a preset threshold of the attitude variation during a predetermined time window (tₐ, t_{b}).

It is further provided an unmanned aerial vehicle capable of being retrieved in a handheld manner, which includes the control device and a flying control system, where

the control device is configured to detect a state parameter of the unmanned aerial vehicle in real time, determine whether the unmanned aerial vehicle is disturbed by a hand according to the state parameter of the unmanned aerial vehicle, and transmit a control instruction to the flying control system if it is determined that the unmanned aerial vehicle is disturbed by the hand; and

the flying control system is configured to control a rotor wing of the unmanned aerial vehicle to stop rotation.

Preferably, the state parameter of the unmanned aerial vehicle includes a position parameter of the unmanned aerial vehicle and an attitude parameter of the unmanned aerial vehicle; and

the control device includes a controller, an accelerator, a first camera, a sonar and a gyroscope,

where the first camera is arranged on a side of the unmanned aerial vehicle facing the ground;

the position parameter of the unmanned aerial vehicle is acquired by fusing data detected by the accelerometer, data of the unmanned aerial vehicle relative to a feature point on the ground detected by the first camera and distance data between the unmanned aerial vehicle and the ground detected by the sonar; and

the attitude parameter of the unmanned aerial vehicle is acquired by fusing the data detected by the accelerometer and data detected by the gyroscope.

Compared with the conventional technology, the present disclosure has the following advantages.

The user retrieves the unmanned aerial vehicle by a hand without using a remote control device. That is, the unmanned aerial vehicle determines whether there is a hand for retrieving the unmanned aerial vehicle, and stops rotation of a rotor wing if there is the hand for retrieving the unmanned aerial vehicle, thus achieving the retrieve of the unmanned aerial vehicle by the hand. With the method according to the present disclosure, the step of operating a remote controller to retrieve the unmanned aerial vehicle by the user is saved, the user does not need a skill to operate the remote controller, and the unmanned aerial vehicle does not need to freely fall during landing. The unmanned aerial vehicle determines whether the unmanned aerial vehicle is disturbed by the hand according to the state parameter of the unmanned aerial vehicle, and when the unmanned aerial vehicle is disturbed by the hand, it is indicated that the unmanned aerial vehicle is being retrieved by hand, the unmanned aerial vehicle controls the rotor wing to stop rotation, thus achieving the retrieve of the unmanned aerial vehicle by the hand. The method is easy to be achieved, the hardware cost of the remote controller is saved, and the skill of operating the remote controller by an operator is not required. The unmanned aerial vehicle has more freedom and is not controlled by other device, and whether to retrieve the unmanned aerial vehicle by a hand is determined directly by collecting parameters of the unmanned aerial vehicle.

### BRIEF DESCRIPTION OF THE DRAWINGS

To illustrate technical solutions according to embodiments of the disclosure or in the conventional technology more clearly, the following briefly describes the drawings according to embodiments of the disclosure. Apparently, the drawings are only some embodiments of the present disclosure, and other drawings may be obtained by those skilled in the art according to those drawings without creative efforts.

FIG. 1 is a flow chart of a first embodiment of a method for retrieving an unmanned aerial vehicle by a hand according the disclosure;

FIG. 2 is a flow chart of a second embodiment of a method for retrieving an unmanned aerial vehicle by a hand according to the disclosure;

FIG. 3 is a schematic diagram of a first embodiment of a device for retrieving an unmanned aerial vehicle by a hand according to a first device embodiment of the disclosure;

FIG. 4 is a schematic diagram of a second embodiment of a device for retrieving an unmanned aerial vehicle by a hand according to the disclosure;

FIG. 5 is a schematic diagram of a first embodiment of an unmanned aerial vehicle capable of being retrieved by a hand according to the disclosure; and

FIG. 6 is a schematic diagram of an unmanned aerial vehicle capable of being retrieved by a hand according to the disclosure.

### DETAILED DESCRIPTION OF THE EMBODIMENTS

The technical solutions of embodiments of the disclosure will be illustrated clearly and completely in conjunction with the drawings of the embodiments of the disclosure. Apparently, the described embodiments are only a few embodiments rather than all embodiments of the disclosure. Any other embodiments obtained by those skilled in the art on the basis of the embodiments of the present disclosure without creative work will fall within the scope of the present disclosure.

To make the above object, features and advantages of the disclosure more obvious and understandable in the following, the embodiments of the disclosure are described in detail in conjunction with the drawings.

### A First Method Embodiment

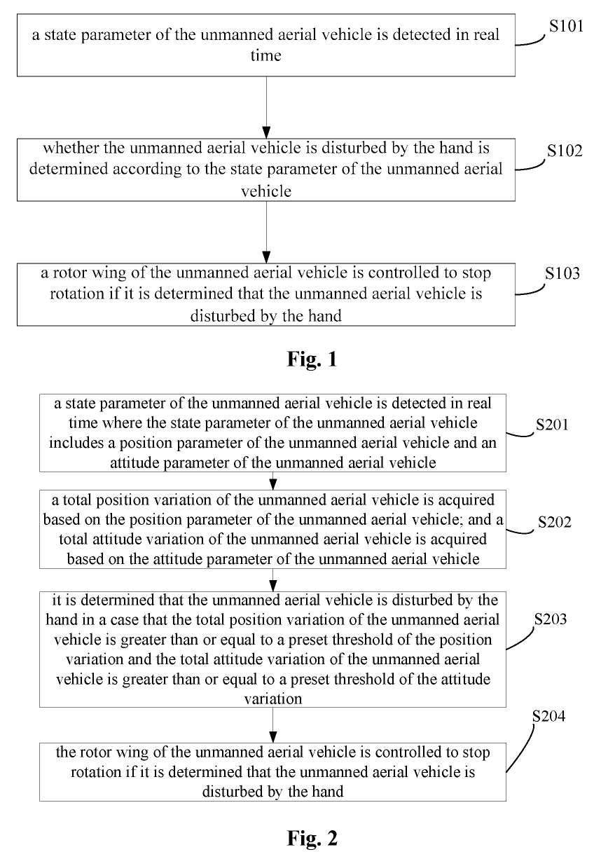

FIG. 1 is a flow chart of a first embodiment of a method for retrieving an unmanned aerial vehicle by a hand according to the disclosure.

The method for retrieving an unmanned aerial vehicle by a hand according to the embodiment is applicable to the unmanned aerial vehicle and the method includes the following steps S101 to S103.

In step S101, a state parameter of the unmanned aerial vehicle is detected in real time.

It should be understood that, with the method for retrieving an unmanned aerial vehicle by a hand according to the disclosure, the unmanned aerial vehicle may be retrieved directly by a hand without using a remote control device. Therefore, the state parameter of the unmanned aerial vehicle is detected by a sensor arranged on the unmanned aerial vehicle, such as an accelerometer and a gyroscope arranged on the unmanned aerial vehicle.

In step S102, whether the unmanned aerial vehicle is disturbed by the hand is determined according to the state parameter of the unmanned aerial vehicle.

It should be understood that, if the unmanned aerial vehicle is retrieved by the hand when flying, the unmanned aerial vehicle receives a resistance of the hand, and a flight state of the unmanned aerial vehicle is changed under the resistance of the hand. Therefore, it is determined that the unmanned aerial vehicle is disturbed by the hand in a case that it is determined that the state parameter of the unmanned aerial vehicle changes.

In step S103, a rotor wing of the unmanned aerial vehicle is controlled to stop rotation if it is determined that the unmanned aerial vehicle is disturbed by the hand.

When the unmanned aerial vehicle is disturbed by the hand, it is indicated that the unmanned aerial vehicle is to be retrieved, and the rotor wing of the unmanned aerial vehicle stops rotation, thus the unmanned aerial vehicle is retrieved directly by the hand without using a remote control device.

In the method for retrieving an unmanned aerial vehicle by a hand according to the embodiment, the user retrieves the unmanned aerial vehicle by a hand without using a remote control device. That is, the unmanned aerial vehicle determines whether there is a hand for retrieving the unmanned aerial vehicle, and stops rotation of a rotor wing if there is the hand for retrieving the unmanned aerial vehicle, thus achieving the retrieve of the unmanned aerial vehicle by the hand. With the method according to the present disclosure, the step of operating a remote controller to retrieve the unmanned aerial vehicle by the user is saved, the user does not need a skill to operate the remote controller, and the unmanned aerial vehicle does not need to freely fall during landing. The unmanned aerial vehicle determines whether the unmanned aerial vehicle is disturbed by the hand according to the state parameter of the unmanned aerial vehicle, and when the unmanned aerial vehicle is disturbed by the hand, it is indicated that the unmanned aerial vehicle is being retrieved by the hand, the unmanned aerial vehicle controls the rotor wing to stop rotation, thus achieving the retrieve of the unmanned aerial vehicle by the hand. The method is easy to be achieved, the hardware cost of the remote controller is saved, and the skill of operating the remote controller by an operator is not required. The unmanned aerial vehicle has more freedom and is not controlled by other device, and whether to retrieve the unmanned aerial vehicle by the hand is determined directly by collecting parameters of the unmanned aerial vehicle.

### A Second Method Embodiment

FIG. 2 is a flow chart of a second embodiment of a method for retrieving an unmanned aerial vehicle by a hand according to the disclosure.

In this embodiment, specific steps for retrieving the unmanned aerial vehicle by the hand are described in detail.

In step S201, a state parameter of the unmanned aerial vehicle is detected in real time where the state parameter of the unmanned aerial vehicle includes a position parameter of the unmanned aerial vehicle and an attitude parameter of the unmanned aerial vehicle.

The position parameter of the unmanned aerial vehicle is acquired by fusing data detected by an accelerometer, data of the unmanned aerial vehicle relative to a feature point on the ground detected by a first camera arranged on a side of the unmanned aerial vehicle facing the ground and distance data between the unmanned aerial vehicle and the ground detected by a sonar.

The attitude parameter of the unmanned aerial vehicle is acquired by fusing the data detected by the accelerometer and data detected by a gyroscope.

It is assumed that the state parameter of the unmanned aerial vehicle is (tᵢ, xᵢ, yᵢ, zᵢ, φᵢ, θᵢ, ψᵢ), where (xᵢ, yᵢ, zᵢ) is the position parameter of the unmanned aerial vehicle at instant tᵢ, xᵢ, yᵢ are two-dimensional coordinates on a plane parallel to the ground respectively, zᵢ is a coordinate on an axis perpendicular to the ground, and tᵢ is a timestamp; (φᵢ, θᵢ, ψᵢ) is the attitude parameter of the unmanned aerial vehicle at instant tᵢ, that is, (φᵢ, θᵢ, ψᵢ) indicate angles of the unmanned aerial vehicle with respect to x-axis, y-axis and z-axis respectively.

In step S202, a total position variation of the unmanned aerial vehicle is acquired based on the position parameter of the unmanned aerial vehicle; and a total attitude variation of the unmanned aerial vehicle is acquired based on the attitude parameter of the unmanned aerial vehicle.

The total position variation of the unmanned aerial vehicle Vₜ_{ᵢ}^{P} is acquired based on the position parameter of the unmanned aerial vehicle with the following equation:

Vₜ_{ᵢ}^{P}=|dxᵢ|+|dyᵢ|+|dzᵢ|.

The total attitude variation of the unmanned aerial vehicle Vₜ_{ᵢ}^{O} is acquired based on the attitude parameter of the unmanned aerial vehicle with the following equation:

Vₜ_{ᵢ}^{O}=|dφᵢ|+|dθᵢ|+|dψᵢ|.

In step S203, it is determined that the unmanned aerial vehicle is disturbed by the hand in a case that the total position variation of the unmanned aerial vehicle is greater than or equal to a preset threshold of the position variation and the total attitude variation of the unmanned aerial vehicle is greater than or equal to a preset threshold of the attitude variation.

Furthermore, the determination may be performed according to the following equation, where t indicates an instant at which the rotor wing stops rotation. In a case that the following equation is satisfied during a period of time from tₐ to t_{b} before t, the rotor wing may be controlled to stop rotation at instant t:

t={Cₜ_{ᵢ}^{P}≧thrₚ&Cₜ_{ᵢ}^{O}≧thr_{O}},

where

$${C}_{{t}_{i}}^{P} = {max}_{i = a}^{b} {V}_{{t}_{i}}^{P} , {C}_{{t}_{i}}^{O} = {max}_{i = a}^{b} {V}_{{t}_{i}}^{O} ,$$

instant t is after instant t_{b}, and the rotor wing is controlled to stop rotation at instant t.

That is, in a case that a maximum value of the total position variation of the unmanned aerial vehicle Vₜ_{ᵢ}^{P} is greater than or equal to the preset threshold thrₚ of the position variation and a maximum value of the total attitude variation of the unmanned aerial vehicle is greater than or equal to the preset threshold thr_{O} of the attitude variation during the period of time from tₐ to t_{b}, the rotor wing may be controlled to stop rotation at instant t after t_{b}.

It should be understood that, the expression that the rotor wing is controlled to stop rotation at an instant after t_{b} refers to that the rotor wing may be controlled to stop rotation at any instant after t_{b}. However, the rotor wing is controlled to stop rotation at an instant that the condition for stopping the rotation of the rotor wing is satisfied for the first time, to stop the rotation of the rotor wing as soon as possible.

For example, a time window for determination is T, a length of T is equal to t_{b}−tₐ, if it is determined that the condition for stopping the rotation of the rotor wing is satisfied in a first time window and the condition for stopping the rotation of the rotor wing is also satisfied in a second time window, the rotation of the rotor wing may be stopped at the end of the first time window, and the determination in the second time window may not be performed.

In step S204, the rotor wing of the unmanned aerial vehicle is controlled to stop rotation if it is determined that the unmanned aerial vehicle is disturbed by the hand.

In this embodiment, whether the unmanned aerial vehicle is disturbed by the hand, i.e., whether the unmanned aerial vehicle receives a resistance from the hand is determined by determining whether the total position variation and the total attitude variation satisfy set conditions. If it is determined that the conditions are satisfied, it is indicated that the unmanned aerial vehicle receives the resistance from the hand, and the user is retrieving the unmanned aerial vehicle by the hand. In this case, the unmanned aerial vehicle controls the rotor wing of the unmanned aerial vehicle to stop rotation thereby achieving the retrieve by the hand.

In addition, it should be noted that the method for retrieving an unmanned aerial vehicle by a hand according to the disclosure is generally applicable to an unmanned aerial vehicle with a rotor wing disposed inside a housing, that is, the housing is disposed outside the rotor wing, and with such arrangement, the hand of the user may not be injured by the rotating rotor wing when retrieving the unmanned aerial vehicle.

With the above method for retrieving an unmanned aerial vehicle by a hand, the step of operating a remote controller to retrieve the unmanned aerial vehicle by the user is saved, the user does not need a skill to operate the remote controller, and the unmanned aerial vehicle does not need to freely fall during landing and thus is protected from damage. In contrast, in the conventional technology, the unmanned aerial vehicle is controlled by the remote controller to fly to a position above an operator and falls freely into a hand of the operator to achieve retrieve. The conventional method for retrieving the unmanned aerial vehicle by remote control has a bad controllability.

On the basis of the method for retrieving an unmanned aerial vehicle by a hand according to the above embodiments, a control device for retrieving an unmanned aerial vehicle by a hand is further provided according to the disclosure, and is described in detail in conjunction with the drawings hereinafter.

### A First Device Embodiment

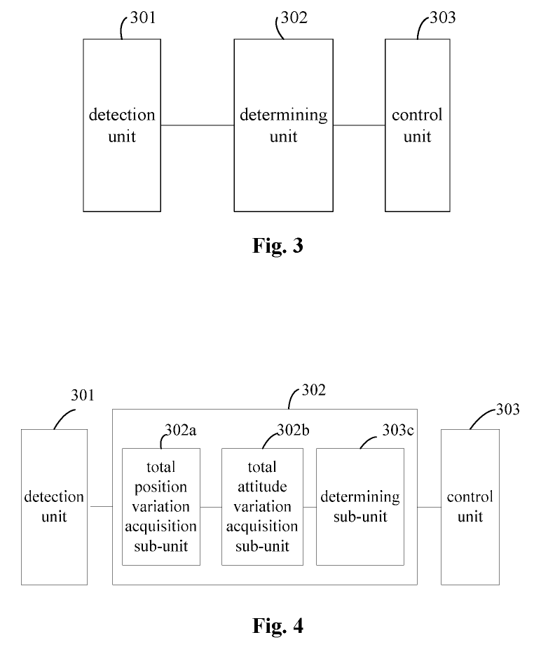

FIG. 3 is a schematic diagram of a first embodiment of a device for retrieving an unmanned aerial vehicle by a hand according to the disclosure.

The control device for retrieving an unmanned aerial vehicle by a hand according to the embodiment is applicable to the unmanned aerial vehicle and the control device includes a detection unit 301, a determining unit 302 and a control unit 303.

The detection unit 301 is configured to detect a state parameter of the unmanned aerial vehicle in real time.

It should be understood that, the control device for retrieving an unmanned aerial vehicle by a hand according to the disclosure is not a remote control device independent of the unmanned aerial vehicle but is arranged on the unmanned aerial vehicle. When the unmanned aerial vehicle is retrieved directly by a hand, the control device can detect a resistance of the hand on the unmanned aerial vehicle. Therefore, the state parameter of the unmanned aerial vehicle is detected by a sensor such as an accelerometer and a gyroscope arranged on the unmanned aerial vehicle.

The determining unit 302 is configured to determine whether the unmanned aerial vehicle is disturbed by the hand according to the state parameter of the unmanned aerial vehicle.

It should be understood that, if the unmanned aerial vehicle is retrieved by the hand when flying, the unmanned aerial vehicle receives the resistance of the hand, and a flight state of the unmanned aerial vehicle is changed under the resistance of the hand. Therefore, it is determined that the unmanned aerial vehicle is disturbed by the hand in a case that it is determined that the state parameter of the unmanned aerial vehicle changes.

The control unit 303 is configured to control a rotor wing of the unmanned aerial vehicle to stop rotation if it is determined that the unmanned aerial vehicle is disturbed by the hand.

When the unmanned aerial vehicle is disturbed by the hand, it is indicated that the unmanned aerial vehicle is to be retrieved, the rotor wing of the unmanned aerial vehicle stops rotation, thus the unmanned aerial vehicle is retrieved directly by the hand without using a remote control device.

The control device for retrieving an unmanned aerial vehicle by a hand according to the embodiment is not a remote control device independent of the unmanned aerial vehicle but is arranged on the unmanned aerial vehicle to enable the unmanned aerial vehicle to be retrieved by the user directly with the hand. That is, the unmanned aerial vehicle determines whether there is a hand for retrieving the unmanned aerial vehicle, and stops rotation of a rotor wing if there is the hand for retrieving the unmanned aerial vehicle, thus achieving the retrieve of the unmanned aerial vehicle by the hand. With the method according to the present disclosure, the step of operating a remote controller to retrieve the unmanned aerial vehicle by the user is saved, the user does not need a skill to operate the remote controller, and the unmanned aerial vehicle does not need to freely fall during landing. The unmanned aerial vehicle determines whether the unmanned aerial vehicle is disturbed by the hand according to the state parameter of the unmanned aerial vehicle, and when the unmanned aerial vehicle is disturbed by the hand, it is indicated that the unmanned aerial vehicle is being retrieved by the hand, the unmanned aerial vehicle controls the rotor wing to stop rotation, thus achieving the retrieve of the unmanned aerial vehicle by the hand. The method is easy to be achieved, the hardware cost of the remote controller is saved, and the skill of operating the remote controller by an operator is not required. The unmanned aerial vehicle has more freedom and is not controlled by other device, and whether to retrieve the unmanned aerial vehicle by the hand is determined directly by collecting parameters of the unmanned aerial vehicle.

### A Second Device Embodiment

FIG. 4 is a schematic diagram of a second embodiment of a device for retrieving an unmanned aerial vehicle by a hand according to the disclosure.

In the device for retrieving an unmanned aerial vehicle by a hand according to the embodiment, a state parameter of the unmanned aerial vehicle includes a position parameter of the unmanned aerial vehicle and an attitude parameter of the unmanned aerial vehicle.

The determining unit 302 includes a total position variation acquisition sub-unit 302a, a total attitude variation acquisition sub-unit 302b and a determining sub-unit 302c.

The total position variation acquisition sub-unit 302a is configured to acquire a total position variation of the unmanned aerial vehicle based on the position parameter of the unmanned aerial vehicle.

The total attitude variation acquisition sub-unit 302b is configured to acquire a total attitude variation of the unmanned aerial vehicle based on the attitude parameter of the unmanned aerial vehicle.

The determining sub-unit 302c is configured to determine that the unmanned aerial vehicle is disturbed by the hand in a case that the total position variation of the unmanned aerial vehicle is greater than or equal to a preset threshold of the position variation and the total attitude variation of the unmanned aerial vehicle is greater than or equal to a preset threshold of the attitude variation.

The total position variation acquisition sub-unit 302a is configured to acquire the total position variation of the unmanned aerial vehicle Vₜ_{ᵢ}^{P} with the following equation:

Vₜ_{ᵢ}^{P}=|dxᵢ|+|dyᵢ|+|dzᵢ|,

where (xᵢ, yᵢ, zᵢ) is the position parameter of the unmanned aerial vehicle at instant tᵢ, xᵢ and yᵢ are two-dimensional coordinates in a horizontal plane parallel to the ground respectively, and zᵢ is a coordinate on an axis perpendicular to the ground.

The total attitude variation acquisition sub-unit 302b is configured to acquire the total attitude variation of the unmanned aerial vehicle Vₜ_{ᵢ}^{O} with the following equation:

Vₜ_{ᵢ}^{O}=|dφᵢ|+|dθᵢ|+|dψᵢ|,

where (φᵢ, θᵢ, ψᵢ) is the attitude parameter of the unmanned aerial vehicle at instant tᵢ.

The determining sub-unit 302c is configured to determine that the unmanned aerial vehicle is disturbed by the hand in a case that a maximum of the total position variation of the unmanned aerial vehicle is greater than or equal to a preset threshold of the position variation and a maximum of the total attitude variation of the unmanned aerial vehicle is greater than or equal to a preset threshold of the attitude variation during a predetermined time window (tₐ, t_{b}).

Furthermore, the determining sub-unit 302c may perform the determination according to the following equation, where t indicates an instant at which the rotor wing stops rotation. In a case that the following equation is satisfied during a period of time from tₐ to t_{b} before t, the rotor wing may be controlled to stop rotation at instant t:

t={Cₜ_{ᵢ}^{P}≧thrₚ& Cₜ_{ᵢ}^{O}≧thr_{O}},

where

$${C}_{{t}_{i}}^{P} = {max}_{i = a}^{b} {V}_{{t}_{i}}^{P} , {C}_{{t}_{i}}^{O} = {max}_{i = a}^{b} {V}_{{t}_{i}}^{O} ,$$

instant t is after instant t_{b}, and the rotor wing is controlled to stop rotation at instant t.

That is, in a case that a maximum value of the total position variation of the unmanned aerial vehicle Vₜ_{ᵢ}^{P} is greater than or equal to the preset threshold thrₚ of the position variation and a maximum value of the total attitude variation of the unmanned aerial vehicle is greater than or equal to the preset threshold thr_{O} of the attitude variation during the time period from tₐ to t_{b}, the rotor wing may be controlled to stop rotation at instant t after t_{b}.

It should be understood that, the expression that the rotor wing is controlled to stop rotation at an instant after t_{b} refers to that the rotor wing may be controlled to stop rotation at any instant after t_{b}. However, the rotor wing is controlled to stop rotation at an instant that the condition for stopping the rotation of the rotor wing is satisfied for the first time, to stop the rotation of the rotor wing as soon as possible.

For example, a time window for determination is T, a length of T is equal to t_{b}−tₐ, if it is determined that the condition for stopping the rotation of the rotor wing is satisfied in a first time window and the condition for stopping the rotation of the rotor wing is also satisfied in a second time window, the rotation of the rotor wing may be stopped at the end of the first time window, and the determination in the second time window may not be performed.

On the basis of the above method and control device for retrieving an unmanned aerial vehicle by a hand, an unmanned aerial vehicle capable of being retrieved by a hand according to the disclosure is further provided, and is described in detail in conjunction with the drawings hereinafter.

### A First Embodiment of an Unmanned Aerial Vehicle

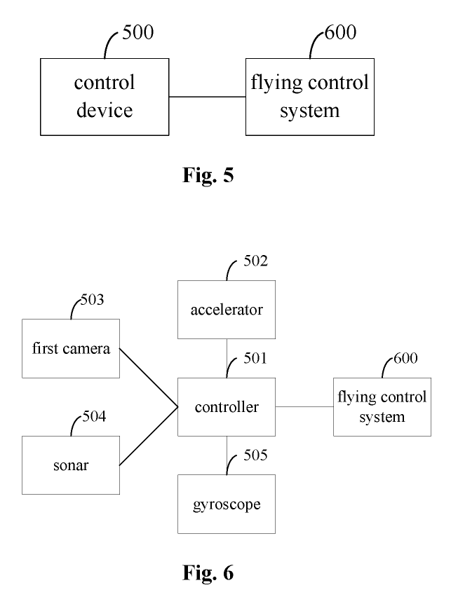

FIG. 5 is a schematic diagram of a first embodiment of an unmanned aerial vehicle according to the disclosure.

The unmanned aerial vehicle according to the embodiment includes the control device 500 according to the above embodiments and a flying control system 600.

It should be understood that the control device 500 may be a processor or a controller. The control device 500 is configured to analyze the detected parameters, determine whether the unmanned aerial vehicle continues or stops flying according to an analysis result, and transmit a control instruction to the flying control system, and the flying control system controls a flight state of the unmanned aerial vehicle according to the control instruction. It should be noted that, the disclosure focuses on the control device, and the flying control system of the unmanned aerial vehicle is not improved and a conventional flying control system may be used in the unmanned aerial vehicle.

The control device 500 is configured to detect a state parameter of the unmanned aerial vehicle in real time, determine whether the unmanned aerial vehicle is disturbed by a hand according to the state parameter of the unmanned aerial vehicle, and transmit a control instruction to the flying control system if it is determined that the unmanned aerial vehicle is disturbed by the hand.

The flying control system 600 is configured to control a rotor wing of the unmanned aerial vehicle to stop rotation.

With the unmanned aerial vehicle according to the embodiment, the unmanned aerial vehicle determines whether there is a hand for retrieving the unmanned aerial vehicle without using a control device, and stops rotation of the rotor wing if there is the hand for retrieving the unmanned aerial vehicle, thus achieving the retrieve of the unmanned aerial vehicle by the hand. The step of operating a remote controller to retrieve the unmanned aerial vehicle by the user is saved, the user does not need a skill to operate the remote controller, and the unmanned aerial vehicle does not need to freely fall during landing. The unmanned aerial vehicle determines whether the unmanned aerial vehicle is disturbed by the hand according to the state parameter of the unmanned aerial vehicle, and when the unmanned aerial vehicle is disturbed by the hand, it is indicated that the unmanned aerial vehicle is being retrieved by the hand, the unmanned aerial vehicle controls the rotor wing to stop rotation, thus achieving the retrieve of the unmanned aerial vehicle by the hand. The method is easy to be achieved, the hardware cost of the remote controller is saved, and the skill of operating the remote controller by an operator is not required. The unmanned aerial vehicle has more freedom and is not controlled by other device, and whether to retrieve the unmanned aerial vehicle by the hand is determined directly by collecting parameters of the unmanned aerial vehicle.

### A Second Embodiment of an Unmanned Aerial Vehicle

FIG. 6 is a schematic diagram of a second embodiment of an unmanned aerial vehicle according the disclosure.

In the unmanned aerial vehicle according to the embodiment, a state parameter of the unmanned aerial vehicle includes a position parameter of the unmanned aerial vehicle and an attitude parameter of the unmanned aerial vehicle.

Besides the controller 501, the control device 500 further includes an accelerator 502, a first camera 503, a sonar 504 and a gyroscope 505.

The first camera 503 is arranged on a side of the unmanned aerial vehicle facing the ground.

The position parameter of the unmanned aerial vehicle is acquired by fusing data detected by the accelerometer 502, data of the unmanned aerial vehicle relative to a feature point on the ground detected by the first camera 503 and distance data between the unmanned aerial vehicle and the ground detected by the sonar 504.

The attitude parameter of the unmanned aerial vehicle is acquired by fusing the data detected by the accelerometer 502 and data detected by the gyroscope 505.

The state parameter detected by the detection devices are sent to the controller 501, and the controller 501 determines whether the unmanned aerial vehicle receives a resistance of the hand.

The unmanned aerial vehicle according to the embodiment can detect the state parameter with sensors arranged on the unmanned aerial vehicle. The control device can determine whether the unmanned aerial vehicle receives the resistance of the hand according to the state parameter detected by the sensors, and transmit the control instruction to the flying control system if it is determined that the unmanned aerial vehicle receives the resistance of the hand, which indicates the unmanned aerial vehicle is being retrieved by the hand. The flying control system may control the unmanned aerial vehicle to stop flying thus achieving the retrieve of the unmanned aerial vehicle by the hand.

The foregoing embodiments are only preferred embodiments of the disclosure and are not meant to limit the disclosure. The preferred embodiments according to the disclosure are disclosed above, and are not intended to limit the disclosure. Those of skills in the art may make, based on the disclosed method and technical content, some variations and improvements on the technical solutions of the disclosure, or make some equivalent variations on the embodiments without departing from the scope of the technical solutions. All simple modifications, equivalent variations and improvements made based on the technical essence of the disclosure without departing from content of the technical solutions of the disclosure fall in the scope of the technical solutions of the disclosure.

1. A method for retrieving an unmanned aerial vehicle by a hand, wherein the method is applicable to the unmanned aerial vehicle and comprises:
detecting a state parameter of the unmanned aerial vehicle in real time;
determining whether the unmanned aerial vehicle is disturbed by a hand according to the state parameter of the unmanned aerial vehicle; and
controlling a rotor wing of the unmanned aerial vehicle to stop rotation if it is determined that the unmanned aerial vehicle is disturbed by the hand.

2. The method for retrieving an unmanned aerial vehicle by a hand according to claim 1, wherein the state parameter of the unmanned aerial vehicle comprises a position parameter of the unmanned aerial vehicle and an attitude parameter of the unmanned aerial vehicle; and
the determining whether the unmanned aerial vehicle is disturbed by a hand according to the state parameter of the unmanned aerial vehicle comprises:
acquiring a total position variation of the unmanned aerial vehicle based on the position parameter of the unmanned aerial vehicle;
acquiring a total attitude variation of the unmanned aerial vehicle based on the attitude parameter of the unmanned aerial vehicle; and
determining that the unmanned aerial vehicle is disturbed by the hand in a case that the total position variation of the unmanned aerial vehicle is greater than or equal to a preset threshold of the position variation and the total attitude variation of the unmanned aerial vehicle is greater than or equal to a preset threshold of the attitude variation.

3. The method for retrieving an unmanned aerial vehicle by a hand according to claim 2, wherein the position parameter of the unmanned aerial vehicle is acquired by fusing data detected by an accelerometer, data of the unmanned aerial vehicle relative to a feature point on the ground detected by a camera arranged on a side of the unmanned aerial vehicle facing the ground and distance data between the unmanned aerial vehicle and the ground detected by a sonar; and
the attitude parameter of the unmanned aerial vehicle is acquired by fusing the data detected by the accelerometer and data detected by a gyroscope.

4. The method for retrieving an unmanned aerial vehicle by a hand according to claim 2, wherein the total position variation of the unmanned aerial vehicle Vₜ_{ᵢ}^{P} is acquired based on the position parameter of the unmanned aerial vehicle with the following equation:
Vₜ_{ᵢ}^{P}=|dxᵢ|+|dyᵢ|+|dzᵢ|,
wherein (xᵢ, yᵢ, zᵢ) is the position parameter of the unmanned aerial vehicle at instant tᵢ, xᵢ and yᵢ are two-dimensional coordinates in a plane parallel to the ground respectively, zᵢ is a coordinate on an axis perpendicular to the ground, and tᵢ is a timestamp; and
the total attitude variation of the unmanned aerial vehicle Vₜ_{ᵢ}^{O} is acquired based on the attitude parameter of the unmanned aerial vehicle Vₜ_{ᵢ}^{O} with the following equation:
Vₜ_{ᵢ}^{O}=|dφᵢ|+|dθᵢ|+|dψᵢ|,
wherein (φᵢ, θᵢ, ψᵢ) is the attitude parameter of the unmanned aerial vehicle at instant tᵢ, and the determining that the unmanned aerial vehicle is disturbed by the hand in a case that the total position variation of the unmanned aerial vehicle is greater than or equal to a preset threshold of the position variation and the total attitude variation of the unmanned aerial vehicle is greater than or equal to a preset a threshold of the attitude variation comprises:
determining that the unmanned aerial vehicle is disturbed by the hand in a case that a maximum of the total position variation of the unmanned aerial vehicle is greater than or equal to the preset threshold of the position variation and a maximum of the total attitude variation of the unmanned aerial vehicle is greater than or equal to the preset threshold of the attitude variation during a predetermined time window (tₐ, t_{b}).

5. A control device for retrieving an unmanned aerial vehicle by a hand, wherein the control device is applicable to the unmanned aerial vehicle and comprises:
a detection unit configured to detect a state parameter of the unmanned aerial vehicle in real time;
a determining unit configured to determine whether the unmanned aerial vehicle is disturbed by a hand according to the state parameter of the unmanned aerial vehicle; and
a control unit configured to control a rotor wing of the unmanned aerial vehicle to stop rotation if it is determined that the unmanned aerial vehicle is disturbed by the hand.

6. The control device for retrieving an unmanned aerial vehicle by a hand according to claim 5, wherein the state parameter of the unmanned aerial vehicle comprises a position parameter of the unmanned aerial vehicle and an attitude parameter of the unmanned aerial vehicle; and
the determining unit comprises:
a total position variation acquisition sub-unit configured to acquire a total position variation of the unmanned aerial vehicle based on the position parameter of the unmanned aerial vehicle;
a total attitude variation acquisition sub-unit configured to acquire a total attitude variation of the unmanned aerial vehicle based on the attitude parameter of the unmanned aerial vehicle; and
a determining sub-unit configured to determine that the unmanned aerial vehicle is disturbed by the hand in a case that the total position variation of the unmanned aerial vehicle is greater than or equal to a preset threshold of the position variation and the total attitude variation of the unmanned aerial vehicle is greater than or equal to a preset threshold of the attitude variation.

7. The control device for retrieving an unmanned aerial vehicle by a hand according to claim 6, wherein the total position variation acquisition sub-unit is configured to acquire the total position variation of the unmanned aerial vehicle Vₜ_{ᵢ}^{P} with the following equation:
Vₜ_{ᵢ}^{P}=|dxᵢ|+|dyᵢ|+|dzᵢ|,
wherein (x₁, yᵢ, zᵢ) is the position parameter of the unmanned aerial vehicle at instant tᵢ, xᵢ and yᵢ are two-dimensional coordinates in a plane parallel to the ground respectively, and zᵢ is a coordinate on an axis perpendicular to the ground; and
the total attitude variation acquisition sub-unit is configured to acquire the total attitude variation of the unmanned aerial vehicle Vₜ_{ᵢ}^{O} with the following equation:
Vₜ_{ᵢ}^{O}=|dφᵢ|+|dθᵢ|+|dψᵢ|,
wherein (φᵢ, θᵢ, ψᵢ) is the attitude parameter of the unmanned aerial vehicle at instant tᵢ, and
the determining sub-unit is configured to determine that the unmanned aerial vehicle is disturbed by the hand in a case that a maximum of the total position variation of the unmanned aerial vehicle is greater than or equal to the preset threshold of the position variation and a maximum of the total attitude variation of the unmanned aerial vehicle is greater than or equal to the preset threshold of the attitude variation during a predetermined time window (tₐ, t_{b}).

8. An unmanned aerial vehicle capable of being retrieved by a hand, comprising a control device and a flying control system, wherein the control device comprises:
a detection unit configured to detect a state parameter of the unmanned aerial vehicle in real time;
a determining unit configured to determine whether the unmanned aerial vehicle is disturbed by a hand according to the state parameter of the unmanned aerial vehicle; and
a control unit configured to control a rotor wing of the unmanned aerial vehicle to stop rotation if it is determined that the unmanned aerial vehicle is disturbed by the hand;
the control device is configured to detect a state parameter of the unmanned aerial vehicle in real time, determine whether the unmanned aerial vehicle is disturbed by a hand according to the state parameter of the unmanned aerial vehicle, and transmit a control instruction to the flying control system if it is determined that the unmanned aerial vehicle is disturbed by the hand; and
the flying control system is configured to control a rotor wing of the unmanned aerial vehicle to stop rotation.

9. The unmanned aerial vehicle capable of being retrieved by a hand according to claim 8, wherein the state parameter of the unmanned aerial vehicle comprises a position parameter of the unmanned aerial vehicle and an attitude parameter of the unmanned aerial vehicle; and
the control device comprises a controller, an accelerator, a first camera, a sonar and a gyroscope,
wherein the first camera is arranged on a side of the unmanned aerial vehicle facing the ground;
the position parameter of the unmanned aerial vehicle is acquired by fusing data detected by the accelerometer, data of the unmanned aerial vehicle relative to a feature point on the ground detected by the first camera and distance data between the unmanned aerial vehicle and the ground detected by the sonar; and
the attitude parameter of the unmanned aerial vehicle is acquired by fusing the data detected by the accelerometer and data detected by the gyroscope.
